(19) United States
(12) Patent Application Publication
(10) Pub. No.: US 2009/0148606 A1
(43) Pub. Date: Jun. 11, 2009

(54) COMPOSITIONS AND METHODS FOR RESTORING PLASTIC COVERS AND LENSES

(75) Inventor: William C. Norville, San Diego, CA (US)

Correspondence Address: Workman Nydegger;1000 Eagle Gate Tower, 60 East South Temple, Salt Lake City, UT, 84111, US

(73) Assignee: LenzSavers, LLC, San Diego, CA (US)

(21) Appl. No.: 11/952,831

(22) Filed: Dec. 7, 2007

(51) Int. Cl. B05D 3/12; B24D 11/00

(52) U.S. Cl. 427/307; 51/295

(57) ABSTRACT

Plastic restoration kits and methods effectively the light transmission and optical clarity properties to a plastic light cover on an automobile or other plastic surface such as a sunglass lens or corrective optical lens. The kits and methods restore plastic surfaces that have been damaged by scratching and/or UV-induced oxidation. The kits and methods utilize polishing and lusterizing compositions having particles selected so as to polish and lusterize a plastic surface and a UV protective composition that forms a hard UV protective coating. The polishing and/or lusterizing compositions may include agglomerated abrasive particles dispersed in a liquid or gel carrier that progressively break down in size when exposed to oxygen and mechanical pressuring during polishing or lusterizing.

### CROSS-REFERENCE TO RELATED APPLICATIONS

Not applicable.

### BACKGROUND OF THE INVENTION

1. The Field of the Invention

The present invention is directed to compositions and methods for removing scratches and oxidative damage from plastic covers and lenses. In particular, the present invention is directed to restoring clarity and shine to plastic headlight covers, optical lenses, other plastic surfaces, and preventing future damage due to scratching and oxidation.

2. The Relevant Technology

Plastic materials have largely replaced glass as an optically transparent covering for automotive headlights. A typical plastic headlight cover is composed of a molded polycarbonate plastic that is formed into an aerodynamic shape that fits the profile of the front of the automobile.

Plastics are superior to glass in a number of respects. Plastics are lighter than glass while having similar clarity, they are more flexible and able to absorb small impacts, and they are much less likely to shatter in response to large impacts. In addition, plastics can readily be molded into a variety of aerodynamic shapes that are more compatible with modern automotive design.

Plastics, however, present a number of disadvantages. For example, they are prone to scratching and UV-induced oxidative damage. And while plastic headlight covers are typically endowed with coatings that protect against scratching and UV damage, such coatings do not provide 100% protection over time. For example, road particles and other hard, abrasive substances can penetrate the protective coating and cause scratching that degrades the optical properties of the plastic. In addition to physically degrading the optical properties of the cover, scratching leads to a number of other processes that can damage the plastic. For example, scratches (from washing and cleaning the surface) that penetrate the protective coating can allow access to the plastic substrate by exhaust emissions and the chemicals in acid rain. Scratches that penetrate the UV coating also allow UV radiation and/or oxygen to access the plastic substrate leading to oxidative damage of the plastic. In addition, heating of the cover produced by high intensity headlights can cause scratches to expand and contract, allowing greater access to the plastic substrate for UV radiation and/or oxygen. Over time, if these processes are left unchecked, plastic headlight covers can become almost opaque, reducing the Lumens, or light output. This naturally creates a safety issue due to reduced headlight intensity and effectiveness.

Replacement is one option for car owners with headlight covers that have been badly damaged by scratching and/or oxidation. Replacing the plastic covers is, however, cost prohibitive for many consumers. For example, the typical cost for replacing headlight covers can run anywhere between $200 and $500 per headlight, not including installation costs.

There are products that are available that purport to restore plastic headlight covers. Most of these products, however, use harsh cleaners or processes, cheap waxes, and metal polish intended for other applications. These products can be very detrimental to the fragile plastic of the lens. Also, whatever benefit is derived from these products is often short lived, as the uncoated lens will quickly become crazed when again exposed to environmental forces.

One example of a product that has been used to remove scratches from plastics is a system called Micro-Mesh™. Another is Permatex, which used sand paper. The Micro-Mesh™ system removes scratches from plastics using a series of rubber-backed sanding cloths with differing sizes of grit. The first step uses a sanding cloth having 2,400 gauge grit. In subsequent steps, sanding cloths of finer grades up to 12,000 gauge grit are used. In addition to using the rubber sanding block, a small amount of antistatic cream is applied after polishing is complete.

The Micro-Mesh™ system, however, has many negative aspects. One negative aspect of using the Micro-Mesh™ system is that a large amount of plastic must be sanded away in order to remove even the tiniest of scratches. That is, it is necessary to remove enough of the plastic surface to at least equal the depth of the scratch. In addition, a sizable area of plastic must be removed in order to avoid causing optical distortion of the plastic in the surrounding area where the scratch was removed. To avoid optical distortion, the user must possess a high level of skill and patience, which requires a high amount of training. Moreover, repeated scratch removals using this system will greatly reduce the thickness of the plastic and destroy its desired protective properties. Another negative aspect of the Micro-Mesh™ sanding system is the large amount of time it takes to perform each of the series of sandings for each type of grit. Yet another negative aspect of the Micro-Mesh™ sanding system is that extensive sanding removes the protective UV coating from the plastic along with the scratches.

Other products use varnishes, such as acrylic spar varnish, to essentially fill in and cover scratches in plastic head light cover. These products are easy and quick to use, but they ultimately do not restore the plastic. A coat of varnish merely covers the scratching and oxidation and does nothing to repair the underlying damage to the plastic. Varnishes and paint generally do not adhere to plastic very well and the varnish is likely to flake off in a short period of time. Moreover, if the refractive index of the varnish coating is dissimilar to that of the underling plastic, each of the filled in scratches will act as a micro lens scattering the light from the headlight. While the headlight may look better after applying the coat of varnish, the varnish will not in fact restore the optical properties of the cover.

### BRIEF SUMMARY OF THE INVENTION

The present invention encompasses novel compositions and methods configured to restore the clarity and light transmission properties of a plastic surface that has been damaged by scratching and ultraviolet induced oxidation. It has been found that such imperfections or flaws in the surface of the plastic can be removed by applying to the plastic surface renewal compositions described herein. The compositions may include, for example, one or more polishing compositions for removing scratches and oxidation from a plastic surface, one or more lusterizing compositions for further smoothing the polished plastic surface and restoring luster, and one or more compositions for restoring UV protection to the plastic surface. Restoring a plastic surface according to the present invention provides long-lasting clarity, light transmission, and a UV protective finish.

The polishing compositions include an abrasive material having an initial grit size in a range of about 50 microns to about 400 microns, preferably in a range of about 60 microns to about 300 microns, and more preferably in a range of about 70 microns to about 200 microns, and most preferably in a range of about 75 microns to about 150 microns. A medium grit polishing composition preferably has an initial grit size of about 50-100 microns, preferably about 60-90 microns, and a heavy grit polishing composition preferably has an initial grit size in a range of about 80-200 microns, preferably about 100-150 microns. The abrasive material is dispersed within an appropriate carrier suitable for use in making polishing compositions. According to one embodiment, the abrasive material in the polishing composition comprises abrasive particles that break down into smaller size particles (e.g., to about 10-50 microns, preferably about 15-45 microns, more preferably about 20-40 microns, and most preferably about 25-35 microns) when exposed to mechanical pressure and oxygen during the polishing process. Prior to use, the polishing compositions are advantageously manufactured and stored in an environment that is substantially oxygen free (e.g., under inert nitrogen).

The lusterizing compositions include an abrasive material having an initial grit size in a range of about 10 microns to about 60 microns, preferably in a range of about 15 microns to about 50 microns, more preferably in a range of about 20 microns to about 45 microns, and most preferably in a range of about 25 microns to about 40 microns. A light abrasive lusterizing composition has an initial grit size in a range of about 20-60 microns, preferably about 25-55 microns. A finish lusterizing composition has an initial grit size of about 10-50 microns, preferably about 15-40 microns. The abrasive material is dispersed within an appropriate carrier suitable for use in making fine polishing compositions. According to one embodiment, the abrasive material comprises abrasive particles that break down into smaller size particles (e.g., about 1-20 microns, preferably about 2-15 microns, more preferably about 2.5-10 microns, and most preferably about 3-8 microns) when exposed to mechanical pressure and oxygen during the luster restoring process. Prior to use, the lusterizing compositions are advantageously manufactured and stored in an environment that is substantially oxygen free (e.g., under inert nitrogen).

The abrasives of the polishing and lusterizing compositions advantageously dispersed within an appropriate liquid or gel carrier known in the art for manufacturing polishing materials. Exemplary carriers may include solvents, such as water and/or organic solvents, thickening agents, emulsifying agents, colorants, and the like.

According to one embodiment, the abrasive particles in the polishing and/or lusterizing compositions are in the form of agglomerates having an initial particle size when stored in a substantially oxygen free environment but progressively break down into smaller particles having a smaller final particle size when exposed to oxygen and mechanical pressure during the polishing and/or lusterizing process. The agglomerates advantageously break down into smaller particles having a final particle size that is less than about 75% of the initial particle size. Preferably, the agglomerates break down into particles having a final particle size that is less than about 50% of the initial particle size, more preferably less than about 33% of the initial particle size, and most preferably less than about 20% of the initial particle size.

The UV protective composition includes a UV protective material dispersed within a carrier having a solvent that, when the composition is worked into a plastic surface by buffing, advantageously causes the UV protective composition to effectively become annealed or melted into the plastic surface. The result is a hardened UV protective coating on the plastic surface that is optically transparent and smooth. The UV protective coating may optionally include a polymerizable material that helps bond the coating to the prepared plastic surface. It is postulated that the polishing and lusterizing compositions may assist in preparing the plastic surface so as to receive and form a stronger bond with the UV protective coating.

The polishing and lusterizing compositions of the invention can be applied in the same manner as conventional polishing compositions, although the results are far superior to conventional compositions. Exemplary apparatus for applying the polishing and lusterizing compositions of the invention include a hand-held buffing or polishing machine, such as rotary, orbital, cordless drills, or oscillating polishing machines, or an open-cell polyurethane buffing pad impregnated with glass fibers. For lighter scratches, it may be advantageous to manually apply the compositions with the open-cell polyurethane buffing pad or with a soft cotton cloth. The compositions of the invention are compatible with existing polishing systems presently used but yield better and longer lasting results.

Almost any type of buffing cloth may work with the compositions of the present invention, including the aforementioned open-cell polyurethane material and cotton pads. Fleece wool, linen, rigid polyurethane, glass wool, and most other natural and synthetic materials work well. The only restraints are that the buffing pad or cloth be sufficiently durable to withstand the mechanical forces of the buffing process, that its stiffness be commensurate with the difficulty of the job in question, and that its component materials not be so hard that they will scratch the plastic surface or heat it up causing it to burn or melt.

According to one embodiment, the invention includes a kit for restoring light transmission and clarity to a scratched and/or oxidized plastic surface. The kit includes at least one polishing composition for removing scratches, oxidative damage and damaged UV protective coating from the plastic surface, at least one lusterizing composition for restoring luster and optical clarity to the plastic surface following use application to the plastic surface following use of the lusterizing composition. The kit may optionally include other components, such as one or more cleaning cloths and/or compositions for use in removing residues from the polishing and lusterizing compositions prior to application of the UV protective composition and one or more polishing or buffing pads or cloths (e.g., two buffing pads composed of reticulated open-cell polyurethane impregnated with glass fibers).

In one embodiment, the invention includes a method for restoring light transmission and clarity to a scratched and/or oxidized plastic surface. The method is designed to allow a practitioner to restore essentially any plastic surface, including but not limited to, plastic headlight covers, other automotive plastic light covers, plastic sunglass lenses, and plastic corrective eyeglass lenses.

An exemplary method according to the invention includes (1) applying a polishing composition to a buffing pad or cloth for polishing and removing scratches and oxidative damage from a plastic surface using the polishing composition and the buffing pad or cloth, (2) applying a lusterizing composition to the same or different buffing pad or cloth and restoring luster and optical clarity to the headlight using the lusterizing composition and the buffing pad or cloth, (3) cleaning the plastic surface to remove any residues from the polishing and lusterizing compositions, and (4) applying an ultraviolet protective composition to the plastic surface. In one embodiment, the open-cell polyurethane buffing pad is impregnated with glass fibers.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 depicts a profilometric scan of an exemplary plastic headlight cover showing undamaged and scratched regions, and a region restored according to an embodiment of the present invention; and

FIG. 2 is a flow-chart of a method according an embodiment of the present invention.

### DETAILED DESCRIPTION OF THE PREFERRED EMBODIMENTS

### I. Introduction and Definitions

The present invention extends to compositions and methods configured to restore clarity and light transmission properties to a plastic headlight cover. In particular, the present invention encompasses novel compositions and methods configured to restore the clarity and light transmission properties of a surface that has been damaged by scratching and ultraviolet induced oxidation. It has been found that such imperfections or flaws in the surface of the plastic can be removed by applying to the plastic surface renewal compositions described herein. The compositions may include, for example, compositions for removing scratches and oxidation from a plastic surface, as well as compositions for polishing, lusterizing, and reapplying an ultraviolet protective coating to the plastic surface. The compositions and methods disclosed herein provide restoration of a damaged plastic surface with the use of abrasives and polishes. The compositions and methods disclosed herein further include compositions for reapplying a UV protective coating. Restoring a plastic surface according to the present invention provides long-lasting clarity, light transmission, and finish.

As used herein, the term “plastic headlight cover” refers to the molded plastic headlight covers that cover the primary lights on late model automobiles. These plastic headlight covers, which are typically made of polycarbonate, are ubiquitous on today's cars because they are generally more durable than glass and plastic can readily be molded into a variety of aerodynamic shapes that fit seamlessly into the front end of the automobile.

One will appreciate, however, that there are many plastic surfaces that can be restored according to the compositions and methods described herein. The methods, and kits disclosed herein are configured to allow a user to efficiently restore any plastic surface that has been damaged by scratching and/or ultraviolet induced oxidation.

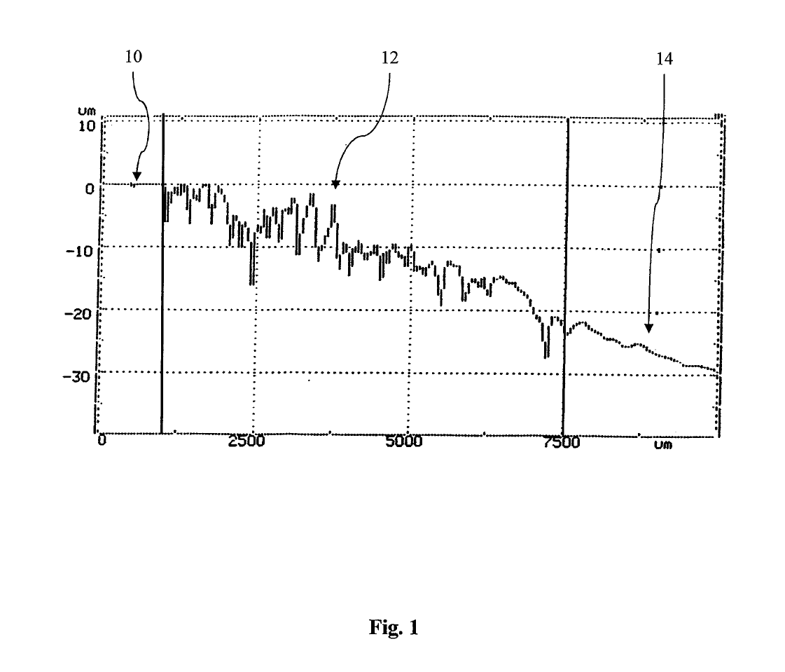

FIG. 1 depicts a profilometric scan of an exemplary plastic surface showing undamaged and scratched regions, and a region restored according to an embodiment of the present invention. Profilometry is a technique that detects irregularities in a surface as a probe scans across the surface. The x-axis of a typical profilometric scan, as shown in FIG. 1, displays the linear distance traveled by the probe across the surface. In this case, the x-axis of FIG. 1 shows that the probe collected data across a linear distance of about 10,000 microns, or about 1 cm. The y-axis of a profilometric scan generally records the magnitude of any irregularities detected as the probe travels linearly across the surface. In this case, the irregularities in the surface are scratches in the plastic.

To prepare the surface of the plastic headlight cover depicted in FIG. 1 some portions were masked off with tape to preserve an undamaged surface while other regions were scratched and then restored. The unmasked region was thoroughly scratched with coarse sandpaper (80 grit) to mimic the scratching and UV damage that occurs over time to a typical plastic headlight cover. Some portions of the scratched surface were then masked off to preserve an example of a damaged surface. The unmasked, damaged region was then restored using the systems and methods disclosed herein.

The scan depicted in FIG. 1 shows these undamaged 10, damaged 12, and restored 14 regions. Undamaged region 10, which ranges on the x-axis from about 0 microns to about 1000 microns, shows a substantially flat surface depicted by the dotted line at Y=0 microns. In contrast, the damaged region 12, which ranges on the x-axis from about 1,000 microns to about 7,500 microns, shows a wavy profile indicative of many deep scratches. In contrast, the restored region 14, which ranges on the x-axis from about 7,500 microns to about 10,000, was restored according the methods of the present invention. Restored region 14 has a substantially more regular profile relative to the damaged region 12. And while the surface of restored region 14 is not perfect, it is greatly improved over the level of scratching observed in scratched region 12.

By comparing the undamaged region 10 to the restored region 14 in FIG. 1, one can appreciate that the restoration process tends to remove a thickness of material from the surface of the plastic of only about 30 microns, or about three one hundredths of a millimeter. This is a very small amount of material, particularly when one considers that the typical headlight cover is several millimeters thick. The plastic surface is restored according to the present invention with the removal of such a small amount of material because the compositions of the invention remove scratches and/or oxidation from the plastic surface without creating additional scratches that have to be removed by progressively finer abrasives. It is also believed that the compositions of the present invention are able to penetrate larger scratches and reform them such that a deep v-shaped cut may be reformed into a shallow u-shaped depression.

The polishing and lusterizing compositions of the present invention can be applied the same way as any polishing compound, although the results are far superior to any of the prior art compounds presently available. The presently preferred method of application for removing scratches from plastic headlight covers and other plastic surfaces is to apply the polishing compounds by means of conventional hand-held buffing or polishing machines, such as rotary, orbital, or oscillating polishing machines, using an open-cell polyurethane buffing pad impregnated with glass fibers. For lighter scratches, it may be preferable to manually apply the compounds with the open-cell polyurethane buffing pad or with a soft cotton cloth. Finally, the compositions of the present invention are compatible with existing polishing systems presently used but yield better results.

It should be understood that almost any type of buffing cloth will work with the compounds of the present invention including the aforementioned open-cell polyurethane material and cotton pads. Fleece wool, linen, rigid polyurethane, glass wool, and most other natural and synthetic materials work well. The only restraints are that the buffing pad or cloth be sufficiently durable to withstand the mechanical forces of the buffing process, that its stiffness be commensurate with the difficulty of the job in question, and that its component materials not be so hard that they will scratch the plastic surface or heat it up causing it to burn or melt.

### II. Exemplary Kits for Restoring Plastic Surfaces

In one embodiment, the present invention includes a kit for restoring optical clarity and light transmission properties to a plastic surface damaged by scratching and/or UV-induced oxidation, comprising. The kit includes at least one polishing composition formulated to readily remove scratches and oxidation from the plastic surface, optionally at least one lusterizing composition for finishing the plastic surface, and at least one UV protective composition.

The polishing compositions comprise an abrasive material having an initial grit size in a range of about 50 microns to about 400 microns, preferably in a range of about 60 microns to about 300 microns, more preferably in a range of about 70 microns to about 200 microns, and most preferably in a range of about 75 microns to about 150 microns. The polishing abrasive may be “heavy grit” or “medium grit”. Heavy grit polishing abrasives have an initial grit size of about 80-200 microns, preferably about 100-150 microns. Medium grit polishing abrasives have an initial grit size of about 50-100 microns, preferably about 60-90 microns.

The polishing abrasive is advantageously dispersed within an appropriate liquid or gel carrier suitable for use in making polishing compositions. Exemplary carriers may include solvents, such as water and/or organic solvents, thickening agents, emulsifying agents, colorants, and the like.

In one embodiment, the abrasive material comprises abrasive particles that progressively break down into smaller size particles when exposed to oxygen and mechanical pressure during the polishing process. According to one embodiment, the polishing abrasive breaks down to a particle size of about 10-50 microns, preferably about 15-45 microns, more preferably about 20-40 microns, and most preferably about 25-35 microns when exposed to mechanical pressure and oxygen during the polishing process. Prior to use, the polishing compositions are advantageously manufactured and stored in an environment that is substantially oxygen free (e.g., under inert nitrogen).

One will of course appreciate that this phenomenon produces a polishing composition that becomes progressively finer during use. This is advantageous when one considers that typical polishing techniques involve using a series of progressively finer abrasives to remove scratches left by the previous abrasive. The polishing composition of the present invention is advantageously formulated to avoid having to use several polishing compositions to achieve a final polished surface in that the polishing composition encompasses many polishing steps in a single step by virtue of the fact that the abrasive particles become progressively finer as the polishing process continues.

The kit may include at least one lusterizing composition formulated to readily restore optical clarity and light transmission properties to the plastic surface following use of the polishing composition. The lusterizing compositions comprise an abrasive material having an initial grit size in a range of about 10 microns to about 60 microns, preferably in a range of about 15 microns to about 50 microns, more preferably in a range of about 20 microns to about 45 microns, and most preferably in a range of about 25 microns to about 40 microns. The lusterizing abrasive may be “light grit” or “fine grit”. Light grit polishing abrasives have an initial grit size of about 20-60 microns, preferably about 25-55 microns. Fine grit polishing abrasives have an initial grit size of about 10-50 microns, preferably about 15-40 microns.

The lusterizing abrasive is advantageously dispersed within an appropriate liquid or gel carrier suitable for use in making polishing and/or finishing compositions. Exemplary carriers may include solvents, such as water and/or organic solvents, thickening agents, emulsifying agents, colorants, and the like.

In one embodiment, the lusterizing composition comprises abrasive particles that progressively break down into smaller size particles when exposed to oxygen and mechanical pressure and oxygen during the lusterizing process. According to one embodiment, the lusterizing abrasive breaks down to a particle size of about 1-20 microns, preferably about 2-15 microns, more preferably about 2.5-10 microns, and most preferably about 3-8 microns when exposed to mechanical pressure and oxygen during the lusterizing process. Prior to use, the lusterizing compositions are advantageously manufactured and stored in an environment that is substantially oxygen free (e.g., under inert nitrogen).

One will of course appreciate that this phenomenon produces a lusterizing composition that becomes progressively finer during use. This is highly advantageous when one considers that typical finishing techniques involve using a series of progressively finer abrasives to remove scratches left by the previous abrasive. The lusterizing composition of the present invention is advantageously formulated to avoid having to use several lusterizing compositions to achieve a final lustrous surface in that the lusterizing composition encompasses many lusterizing steps in a single step by virtue of the fact that the abrasive particles become progressively finer as the lusterizing process continues.

According to one embodiment, the abrasive particles in the polishing and/or lusterizing compositions are in the form of agglomerates having an initial particle size when stored in a substantially oxygen free environment but progressively break down into smaller particles having a smaller final particle size when exposed to oxygen and mechanical pressure during the polishing and/or lusterizing process. The agglomerates advantageously break down into smaller particles having a final particle size that is less than about 75% of the initial particle size. Preferably, the agglomerates break down into particles having a final particle size that is less than about 50% of the initial particle size, more preferably less than about 33% of the initial particle size, and most preferably less than about 20% of the initial particle size.

The kit includes at least one composition for applying a UV protective coating to the plastic surface following application of the polishing and lusterizing compositions. Unfortunately, the process of restoring a plastic surface with the above described kit typically removes the factory applied UV protective coating from the plastic surface. Without a protective coating, the surface would quickly be degraded by scratching and UV induced oxidation. The UV protective composition includes a UV protective material dispersed within a carrier having a solvent that advantageously causes the UV protective composition to effectively become annealed or melted into the plastic surface during the buffing process. The result is a hardened UV protective coating on the plastic surface that is optically transparent and smooth. The UV protective coating may optionally include a polymerizable material that helps bond the coating to the prepared plastic surface. It is postulated that the polishing and lusterizing compositions may assist in preparing the plastic surface so as to receive and form a stronger bond with the UV protective coating by activating the surface and creating bonding sites where the protective composition can form physical and chemical bonds to the plastic surface.

In the past, transparent protective coatings of high optical quality for UV protection, have been obtained on plastic substrates by spin and dip coating, followed by baking. The UV protective compositions of the invention allow for low temperature application (T<130° F.), which is achieved by the chemical dispersion of the UV protective coating within a solvent carrier, which causes the coating to anneal itself to a headlight lens similar to the way it is done in the original manufacturing process. It is believe that solids in the coating are made of crystalline and UV protective nano particles that coalesce into larger particles by means of a polyermizable material. This causes deposition of the UV protective particles as a thick single layer (>400 nm).

The smallest stable resistivity so far obtained is ρ=9×10⁻² Ω·cm (sheet resistance of 1.6 kΩ for a 570 nm thick single layer). The transparency in the visible range is high, T≠87%, the abrasion resistance is in agreement with DIN 58-196-G10, and the hardness according to ASTM D 3363-92a is 1 H. The application process allows for antiglare coatings with an adjustable gloss of 60 to 80 GU and an optical resolution >8 lines/mm.

The kit may include at least one buffing pad or buffing cloth for applying the polishing and lusterizing compositions to the plastic surface. The buffing pad or buffing cloth can either be used manually or they can be attached to a drill or a mechanical polisher. In one embodiment, the buffing pad or buffing cloth are impregnated with glass fibers to enhance the action of the polishing and lusterizing compounds. It is believed that the glass fibers enhance the action of the polishing and lusterizing compounds by penetrating or “reaching” into deep scratches such that deep scratches are reformed from deep v-shaped grooves to shallow u-shaped depressions. By reforming the surface, the glass fibers allows some scratches to be restored without having to remove a layer of plastic from the plastic surface without having to remove a layer of plastic equal to the depth of the deepest scratch.

### III. Exemplary Methods for Restoring Plastic Surfaces

In one embodiment, the present invention includes a method for restoring light transmission and clarity to a scratched and/or oxidized plastic surface. The method is configured to allow a practitioner to restore essentially any plastic surface. Examples of plastics surfaces that can be restored according to the present invention include plastic headlight covers, other plastic automotive light covers, and plastic eyeglass lenses, including sunglass lenses and plastic corrective lenses.

An exemplary method according to the invention includes (1) applying a polishing composition to a buffing pad or cloth for polishing and removing scratches and oxidative damage from a plastic surface using the polishing composition and the buffing pad or cloth, (2) applying a lusterizing composition to the same or different buffing pad or cloth and restoring luster and optical clarity to the headlight using the lusterizing composition and the buffing pad or cloth, (3) cleaning the plastic surface to remove any residues from the polishing and lusterizing compositions, and (4) applying an ultraviolet protective composition to the plastic surface. In one embodiment, the open-cell polyurethane buffing pad is impregnated with glass fibers.

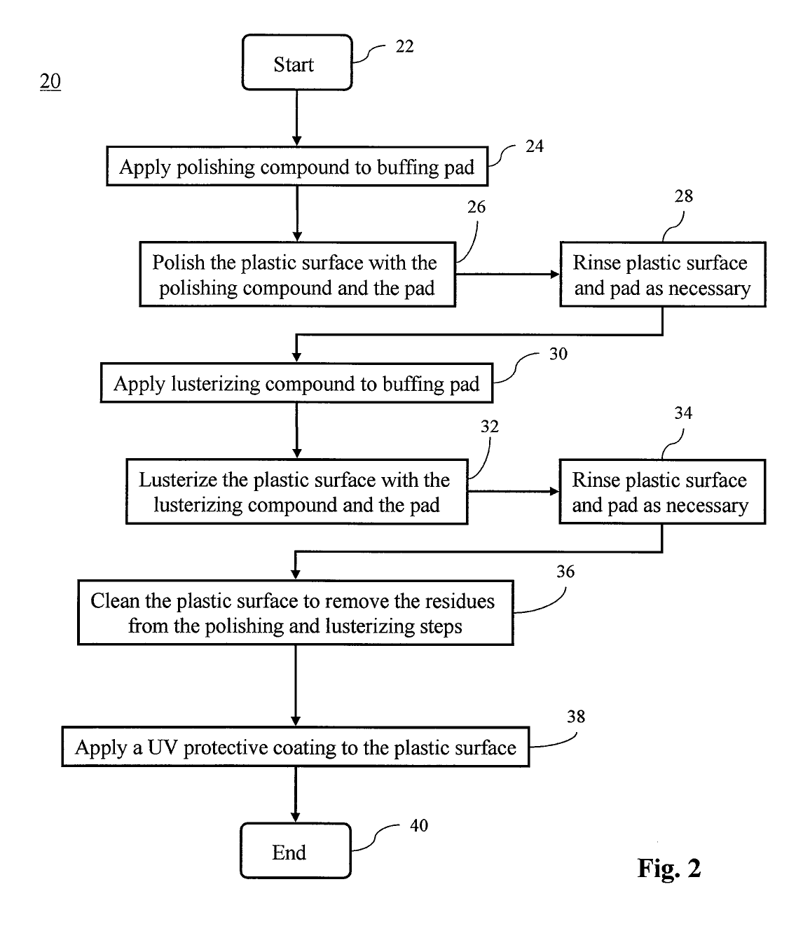

FIG. 2 depicts a flow-chart 20 of one embodiment of a method for restoring essentially any type of plastic surface that has been damaged by scratching and/or UV-induced oxidation. Flow-chart 20 starts at 22 and ends at 40. In one embodiment, the method includes applying a polishing composition to an open-cell polyurethane buffing pad 24. The polishing composition and the buffing pad are used for polishing and removing scratches and oxidative damage from a plastic surface 26. In one embodiment, the open-cell polyurethane buffing pad may be impregnated with glass fibers. It is believed that the polishing composition and the glass fibers are able to penetrate or reach into larger scratches in the plastic surface and reform the scratches from a deep v-shaped gouge to a u-shaped depression. It is this property of the polishing system that allows larger scratches to be removed without having to remove a layer of plastic equal to the depth of the deepest scratch.

The buffing pad and the polishing composition may be used for polishing and removing scratches and oxidative damage from a plastic surface by attaching the buffing pad to a conventional hand-held polishing or buffing machine. Alternatively, the buffing pad can be used manually with the first abrasive composition for polishing and removing scratches and oxidative damage from a plastic surface. The plastic surface can be rinsed as necessary 28 in order to wash away dirt and/or plastic residue, and to provide lubrication between the plastic surface and the buffing pad and polishing composition.

One will of course appreciate that this phenomenon produces a polishing composition that becomes progressively finer during use. This is highly advantageous when one considers that typical polishing techniques involve using a series of progressively finer abrasives to remove scratches left by the previous abrasive. The polishing composition of the present invention is advantageously formulated to avoid having to use several polishing compositions to achieve a final polished surface in that the polishing composition encompasses many polishing steps in a single step by virtue of the fact that the abrasive particles become progressively finer as the polishing process continues.

In one embodiment, the method includes applying a lusterizing composition to the open-cell polyurethane buffing pad 30. The lusterizing composition and the buffing pad are used for restoring the lumonious output and luster to the plastic surface 32. The buffing pad and the lusterizing composition may be used for restoring luster to the plastic surface by attaching the buffing pad to a conventional cordless drill or air and electric hand-held polishing or buffing machine. Alternatively, the buffing pad can be used manually with the lusterizing composition for restoring luster to the plastic surface. The plastic surface can be rinsed as necessary 34 in order to wash away dirt and/or plastic residue, and to provide lubrication between the plastic surface and the buffing pad and lusterizing composition.

One will of course appreciate that this phenomenon produces a lusterizing composition that becomes progressively finer during use. This is highly advantageous when one considers that typical lusterizing techniques involve using a series of progressively finer abrasives to remove scratches left by the previous abrasive. The lusterizing composition of the present invention is advantageously formulated to avoid having to use several lusterizing compositions to achieve a final lustrous surface in that the lusterizing composition encompasses many lusterizing steps in a single step by virtue of the fact that the abrasive particles become progressively finer as the lusterizing process continues.

In one embodiment, the method includes cleaning the plastic surface to remove residues from the polishing and luster restoring steps 36. Cleaning can be achieved with a spray of water or with a damp cloth. Generally, the cleaning step should be conducted with care to avoid rescratching the plastic surface. Moreover, the cleaning step should be conducted with utmost care to remove all of the residues from the polishing and luster restoring steps prior to the application of a UV-protective coating.

In one embodiment, the method includes a step of applying a UV-protective composition to the plastic surface 38. Generally, the factory-applied UV-protective coating is removed in the process of polishing and restoring luster to the plastic surface. If a new UV-protective coating is not applied, exposure to the elements would quickly degrade the plastic surface and the benefits of the restoration would be lost.

In one embodiment, the ultraviolet protective composition comprises at least one solvent that allows the coating to anneal to the plastic surface, at least one polymer or polymerizable compound that forms a hard, clear coating on the plastic surface, and at least one ultra-violet protective compound that protects the plastic surface from future UV induced damage.

In one embodiment, the solvent in the UV protective composition includes at least one ether compound. In an alternative embodiment, the solvent is an alcohol. When ether is the main solvent, the ether compound preferably constitutes about 1% to about 20% of the UV protective composition, calculated on a weight/weight basis. More preferably, the ether compound constitutes about 5% to about 15% and most preferably, about 8-12%. When alcohol is the main solvent, the alcohol preferably constitutes about 70% to about 98% of the UV protective composition, calculated on a weight/weight basis. More preferably, the alcohol constitutes about 80% to about 95% of the UV protective composition. Most preferably, the alcohol constitutes about 87% to about 93%. Exemplary ether compounds include dipropylene glycol n-butyl ether and ethylene glycol monobutyl ether. Exemplary alcohols include isopropyl alcohol. The solvent may also consist of a blend of alcohol and ether compounds without departing from the spirit of the invention.

In one embodiment, the polymer or polymerizable compound that forms a hard, clear coating on the plastic surface includes at least one acrylic-urethane hybrid polymer dispersion. Exemplary acrylic-urethane hybrid polymer dispersions include Hybridur 570™ and Hybridur 580™, which are available from Air Products and Chemical, Inc. Hybridur 570™ and Hybridur 580™ may be used alone or in combination. Preferably, Hybridur 570™ constitutes about 40% to about 65% of the ultraviolet protective composition, calculated on a weight/weight basis. More preferably, Hybridur 570™ constitutes about 45% to about 60% of the ultraviolet protective composition, calculated on a weight/weight basis. Most preferably, Hybridur 570 constitutes about 50% to about 55% of the ultraviolet protective composition, calculated on a weight/weight basis. Preferably, Hybridur 580™ constitutes about 10% to about 35% of the ultraviolet protective composition, calculated on a weight/weight basis. More preferably, Hybridur 580™ constitutes about 15% to about 30% of the ultraviolet protective composition, calculated on a weight/weight basis. Most preferably, Hybridur 580™ constitutes about 20% to about 25% of the ultraviolet protective composition, calculated on a weight/weight basis.

In another embodiment, the polymer or polymerizable compound that forms a hard, clear coating on the plastic surface includes at least one acrylic polymer. An exemplary acrylic polymer is Elvacite 2776™, which is available from Lucite International. Preferably, Elvacite 2776™ constitutes about 0.5% to about 10% of the ultraviolet protective composition, calculated on a weight/weight basis. More preferably, Elvacite 2776™ constitutes about 1% to about 8% of the ultraviolet protective composition, calculated on a weight/weight basis. Most preferably, Elvacite 2776™ constitutes about 2% to about 5% of the ultraviolet protective composition, calculated on a weight/weight basis.

The ultraviolet protective coating includes at least one ultraviolet protective compound to protect the plastic surface from UV-induced damage. Exemplary ultraviolet protective compounds are hindered amine compounds, such as Tinuvin 384™ and Tinuvin 292™, which are available from Ciba, benzophenones, benzotriazoles, hydroxyphenyltriazines, and hydroxyphenylbenzotriazoles. Preferably, the ultraviolet protective compound or compounds constitute about 0.01% to about 1% of the ultraviolet protective coating, calculated on a weight/weight basis. More preferably, the ultraviolet protective compound or compounds constitute about 0.05% to about 0.5% of the ultraviolet protective coating, calculated on a weight/weight basis. Most preferably, the ultraviolet protective compound or compounds constitute about 0.1% to about 0.3% of the ultraviolet protective coating, calculated on a weight/weight basis.

Additional ingredients which may be included in the ultraviolet protective composition include wetting agents to improve the uniformity of the coating, plasticizers to increase the durability of the coating, and antifoaming agents to discourage the formation of air bubbles in the ultraviolet protective coating as it is applied to the plastic surface. Exemplary wetting agents include polyether modified siloxanes, such as BYK-345™, BYK-346™, BYK-347™, BYK-348™, BYK-349™, which are available from BYK Chemie, Inc, and sodium dioctyl sulfosuccinate, which is available from Cytec. Exemplary plasticizers include derivatives of citric acid, such as triethyl citrate, acetyl triethyl citrate, tributyl citrate, acetyl tributyl citrate, and tri-(2-ethylhexyl)-citrate. Exemplary defoamers include the Surfynol™ line of chemicals available from Air Products and Chemicals, Inc.

### EXAMPLES OF SPECIFIC FORMULAS

Below are specific examples of compositions and methods which have been created according to the present invention.

### EXAMPLE 1

A medium abrasive polishing composition in accordance with the present invention was prepared with the following formulation:

| | % W/W |
|---|---|
| Solid abrasive material | 30.0 |
| Propylene Glycol | 5.0 |
| Carboxymethyl Cellulose | 1.0 |
| Ethylene Oxide/Propylene | 2.5 |
| Oxide Block Copolymer | |
| Fragrance 98164 | 0.2 |
| 1-(3-chloroallyl)-3,5,7-Triaza-1- | 0.2 |
| azonia adamantane chloride | |

Sufficient deionized water was added to bring the total volume to 100 percent (w/w).

The composition is prepared, packaged, and stored in a substantially oxygen free environment. For example, the dry material is added to a mixing apparatus. Subsequently, the dry materials and the mixer are exposed to a vacuum such that essentially all oxygen is evacuated from the dry ingredients. An inert gas such as nitrogen is added back to the mixing apparatus, the liquid ingredients are added, and the composition is mixed. The composition is subsequently packaged in a substantially oxygen free environment.

It is believed that preparing and packaging the composition under oxygen free conditions allows the abrasive particles to agglomerate into larger particles. It is postulated that this aggregation occurs in a substantially oxygen free environment because the lack of oxygen alters the surface charge properties of the abrasive particles. A person having ordinary skill in the art will appreciate that this aggregation is progressively reversed when the abrasive particles are exposed to oxygen and mechanical pressure during the polishing process.

This formulation exhibited a creamy viscous lotion consistency, and was cream in color. In this and other examples coconut fragrance was added for aesthetic purposes only, and it should be understood that fragrance could be omitted or substituted without altering the efficiency of the polishing composition. This formulation has a wide variety of uses for removing scratches from plastic surfaces. It is a presently preferred composition for initial treatment for polishing and removal of scratches and oxidative damage from plastic headlight covers.

A heavy to medium abrasive formula in accordance with this example would also be useful for initial treatment in restoring and repairing plastic material such as plastic windows, plastic or acrylic furniture, plastic shields on face masks, light bars on police vehicles, ski trams or gondolas, the faces of advertising signs, and many other applications.

Although the formulation set forth above is the presently preferred formulation, it should be understood that various alterations may be made without departing from the broader teachings of the present invention. In this example, the solid polishing material may include a blend of kaolinitic quartz, silicon dioxide, and calcined alumina. The particle size of the polishing materials ranged from about 50 microns to about 400 microns. Although it is preferred that the total abrasives content be about 23%, a broader range of abrasive content is about 15% to about 35% with a more preferred range being about 20% to about 30%. In formulating a heavy to medium abrasive formulation of the type set forth in this example, it is to be understood that variations in the ratio of amounts of the remaining constituents may be made as required to maintain their function.

### EXAMPLE 2

A light abrasive lusterizing composition in accordance with the present invention was prepared with the following formulation:

| | % W/W |
|---|---|
| Solid abrasive material | 30.0 |
| Propylene Glycol | 5.0 |
| Carboxymethyl Cellulose | 1.0 |
| Ethylene Oxide/Propylene | 2.5 |
| Oxide Block Copolymer | |
| Fragrance 98164 | 0.2 |
| 1-(3-chloroallyl)-3,5,7-Triaza-1- | 0.2 |
| azonia adamantane chloride | |

Sufficient deionized water was added to bring the total volume to 100 percent (w/w), which yielded a viscous, creamy fluid with a lotion-like consistency. In this and other examples coconut fragrance was added for aesthetic purposes only, and it should be understood that fragrance could be omitted or substituted without altering the efficiency of the polishing composition.

The composition is prepared, packaged, and stored in a substantially oxygen free environment. For example, the dry material is added to a mixing apparatus. Subsequently, the dry materials and the mixer are exposed to a vacuum such that essentially all oxygen is evacuated from the dry ingredients. An inert gas such as nitrogen is added back to the mixing apparatus, the liquid ingredients are added, and the composition is mixed. The composition is subsequently packaged in a substantially oxygen free environment.

It is believed that preparing and packaging the composition under oxygen free conditions allows the abrasive particles to aggregate into larger particles. It is postulated that this aggregation occurs in a substantially oxygen free environment because the lack of oxygen alters the surface charge properties of the abrasive particles. A person having ordinary skill in the art will appreciate that this aggregation is progressively reversed when the abrasive particles are exposed to oxygen and mechanical pressure during the polishing process.

This light abrasive formulation has a variety of uses, but is particularly preferred as a lusterizing treatment for plastics first treated with the polishing composition of Example 1. It is preferred for use on plastic headlight covers, plastic windows, plastic or acrylic furniture, plastic shields on face masks, light bars on police vehicles, ski trams or gondolas, the faces of advertising signs, and many other applications. It would also be useful for buffing or removing minor scratches, hazing and discoloration from other plastics, particularly for removing scratches from eyeglass lenses (e.g., sunglass lenses and/or corrective lenses.

Although the formulation set forth above is the presently preferred formulation, it should be understood that various alterations may be made without departing from the broader teachings of the present invention. In this example, the solid polishing material included a blend of kaolinitic quartz, silicon dioxide, and calcined alumina. The particle size of the polishing materials ranged from about 1 micron to about 50 microns. Although it is preferred that the total abrasives content be about 23%, a broader range of abrasive content is about 15% to about 35% with a more preferred range being about 20% to about 30%. In formulating a light abrasive formulation of the type set forth in this example, it is to be understood that variations in the ratio of amounts of the remaining constituents may be made as required to maintain their function.

### EXAMPLE 3

A heavy abrasive polishing composition in accordance with the present invention was prepared with the following formulation:

| Ingredient | Trade Name/Supplier | % W/W |
|---|---|---|
| Magnesium Aluminum Silicate (5% | Van Gel/RT Vanderbilt | 30.0 |
| dispersion) | | |
| Propylene Glycol | Propylene Glycol | 5.0 |
| Carboxymethyl Cellulose | CMC 7H or CMC | 1.0 |
| | 9M31XF/Aqualon-Hercules | |
| Aluminum Silicate | Kaopolite/Kaopolite Co. | 18.0 |
| Fused Silica (8.8 microns average) | Siltex 44/Kaopolite Co. | 3.0 |
| Boehmite Alumina (60 microns average) | Catapal D/Sasol (formerly Vista) | 2.0 |
| Ethylene Oxide/Propylene Oxide Block | Tergitol 15-S-7/Dow | 2.5 |
| Copolymer | | |
| Fragrance 98764 | Fragrance 98764/Noville | 0.2 |
| 1-(3-chloroallyl)-3,5,7-Triaza-1-azonia- | Dowicil 75 | 0.2 |
| adamantane chloride | | |
| Deionized water | | q.s. to 100 |

This heavy formulation is useful for quick removal of scratches from most of the plastic materials listed in Example 1, although it would not likely be used with compact discs or the like. A medium formulation such as set forth in Example 1 and/or a light formulation as set forth in Example 2 might be used to complete the repair after an initial treatment with this heavy formulation.

### EXAMPLE 4

A medium abrasive polishing composition in accordance with the present invention was prepared with the following formulation:

| Ingredient | Trade Name/Supplier | % W/W |
|---|---|---|
| Magnesium Aluminum Silicate (5% | Van Gel/RT Vanderbilt | 30.0 |
| dispersion) | | |
| Propylene Glycol | Propylene Glycol | 5.0 |
| Carboxymethyl Cellulose | CMC 7H or CMC | 1.0 |
| | 9M31XF/Aqualon-Hercules | |
| Aluminum Silicate | Kaopolite/Kaopolite Co. | 8.0 |
| Celite Diatomaceous Silica | Super Floss or Snow Floss/Celite | 7.0 |
| Boehmite Alumina | Catapal D/Sasol (formerly Vista) | 8.0 |
| Ethylene Oxide/Propylene Oxide Block | Tergitol 15-S-7/Dow | 2.5 |
| Copolymer | | |
| Fragrance 98764 | Fragrance 98764/Noville | 0.2 |
| 1-(3-chloroallyl)-3,5,7-Triaza-1-azonia- | Dowicil 75 | 0.2 |
| adamantane chloride | | |
| Deionized water | | q.s. to 100 |

This formulation is suitable for many uses, such as those described in Example 1. The boehmite aluminum has the advantage of being relatively soft. It will break into smaller fragments during use, assisting in repair of the increasingly small scratches which exist during the course of repair.

### EXAMPLE 5

A fine abrasive lustering composition in accordance with the present invention was prepared with the following formulation:

| Ingredient | Trade Name/Supplier | % W/W |
|---|---|---|
| Magnesium Aluminum Silicate | Van Gel/RT Vanderbilt | 30.0 |
| (5% dispersion) | | |
| Propylene Glycol | Propylene Glycol | 5.0 |
| Carboxymethyl Cellulose | CMC 7H or CMC | 1.0 |
| | 9M31XF/Aqualon-Hercules | |
| Aluminum Silicate | Kaopolite/Kaopolite Co. | 23.0 |
| Ethylene Oxide/Propylene | Tergitol 15-S-7/Dow | 2.5 |
| Oxide Block Copolymer | | |
| Fragrance 98764 | Fragrance 98764/Noville | 0.2 |
| 1-(3-chloroallyl)-3,5,7-Triaza- | Dowicil 75 | 0.2 |
| 1-azonia-adamantane chloride | | |
| Deionized water | | q.s. to 100 |

This fine abrasive formulation is similar to Example 2 but has a finer abrasive. As with Example 2, this lusterizing composition has a variety of uses, but is particularly preferred as a final treatment for plastic surfaces first treated with the composition of Example 1 and/or Example 3.

### EXAMPLE 6

A light abrasive polishing composition has the following formulation:

| Ingredient | Trade Name/Supplier | % W/W |
|---|---|---|
| Magnesium Aluminum Silicate | Van Gel/RT Vanderbilt | 30.0 |
| (5% dispersion) | | |
| Propylene Glycol | Propylene Glycol | 5.0 |
| Carboxymethyl Cellulose | CMC 7H or CMC | 1.0 |
| | 9M31XF/Aqualon-Hercules | |
| Aluminum Silicate | Kaopolite/Kaopolite Co. | 11.5 |
| Zirconia (2-4 microns average) | | 11.5 |
| Ethylene Oxide/Propylene Oxide | Tergitol 15-S-7/Dow | 2.5 |
| Block Copolymer | | |
| Fragrance 98764 | Fragrance 98764/Noville | 0.2 |
| 1-(3-chloroallyl)-3,5,7-Triaza-1- | Dowicil 75 | 0.2 |
| azonia-adamantane chloride | | |
| Deionized water | | q.s. to 100 |

This example includes zirconia (zirconium oxide) as an abrasive. This is a hard material that should be used with care.

### EXAMPLE 7

An ultraviolet protective coating was prepared in accordance with the present invention with the following formulation:

| Ingredient description | Trade name | % W/W |
|---|---|---|
| Dipropylene Glycol | Arcosolve DPnB | 9.8 |
| n-Butyl Ether | | |
| Polyether modified | BYK-346 | 0.5 |
| polydimethylsiloxane | | |
| Light stabilizer | Tinuvin 384 | 0.7 |
| Light stabilizer | Tinuvin 292 | 0.4 |
| Urethane Hybrid Polymer | Hybridur 570 Polymer | 51.5 |
| | Dispersion | |
| Urethane Hybrid Polymer | Hybridur 580 Polymer | 22.1 |
| | Dispersion | |
| Defoamer | Surfynol DF-58 | 0.2 |
| Water, DI | Water, DI | 14.9 |
| | TOTAL | 100.0 |

The coating composition appeared as a uniform flowable liquid. This light ultraviolet protective coating has a variety of uses, but is particularly preferred as a coating for restoring a UV protective layer to plastic surfaces treated with one or more of the compositions of Examples 1-6. It is preferred for use on plastic headlight covers, plastic windows, plastic or acrylic furniture, plastic shields on face masks, light bars on police vehicles, ski trams or gondolas, the faces of advertising signs, and many other applications. It would also be useful for applying a UV protective coating to other plastics, particularly eyeglass lenses (e.g., sunglass lenses and/or corrective lenses.

Although the formulation set forth above is the presently preferred formulation, it should be understood that various alterations may be made without departing from the broader teachings of the present invention. In formulating an ultraviolet protective coating formulation of the type set forth in this example, it is to be understood that variations in the ratio of amounts of the remaining constituents as required to maintain their function.

### EXAMPLE 8

An ultraviolet protective coating was prepared in accordance with the present invention with the following formulation:

| Ingredient | Trade Name/Supplier | % w/w |
|---|---|---|
| Isopropyl alcohol | Any suitable vendor | 88.85 |
| Acrylic polymer | Elvacite 2776/Lucite | 3.0 |
| | International | |
| Sodium dioctyl | Aerosol OT-75/Cytec | 0.05 |
| sulfosuccinate, 75% | | |
| Triethyl citrate | Citroflex 2/Morflex | 0.3 |
| Ethylene Glycol | Dowanol EB/Dow | 7.0 |
| monobutyl ether | | |
| Light stabilizer | Tinuvin 384/Ciba | 0.5 |
| Light stabilizer | Tinuvin 292/Ciba | 0.3 |
| | TOTAL | 100.0 |

The coating composition appeared as a uniform flowable liquid and dried to a hard, clear surface in approximately 30 minutes.

### EXAMPLE 9

An ultraviolet protective coating was prepared in accordance with the present invention with the following formulation:

| Ingredient | Trade Name/Supplier | % w/w |
|---|---|---|
| Isopropyl alcohol | Any suitable vendor | 90.95 |
| Acrylic polymer | Elvacite 2776/Lucite | 3.0 |
| | International | |
| Sodium dioctyl sulfosuccinate, 75% | Aerosol OT-75/Cytec | 0.05 |
| Dipropylene Glycol n-Butyl Ether | Arcosolve DPnB/Arco | 5.0 |
| Light stabilizer | Tinuvin 384/Ciba | 0.5 |
| Light stabilizer | Tinuvin 292/Ciba | 0.3 |
| Antifoam | Surfynol DF-58/ | 0.2 |
| | Air Products | |
| | TOTAL | 100.0 |

The coating composition appeared as a uniform flowable liquid and dried to a hard, clear surface in approximately 30 minutes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A kit for restoring optical clarity and light transmission properties to a plastic surface damaged by scratching and/or UV-induced oxidation, comprising:
at least one polishing composition having a polishing abrasive with a grit size in a range of about 50 microns to about 400 microns dispersed within a liquid or gel carrier;
at least one lusterizing composition having a lusterizing abrasive with a grit size in a range of about 10 microns to about 60 microns dispersed within a liquid or gel carrier; and
at least one UV protective composition for applying a UV protective coating to a plastic surface treated using the polishing and lusterizing compositions.

2. A kit as recited in claim 1, the polishing abrasive having a grit size in a range of about 60 microns to about 300 microns and the lusterizing abrasive having a grit size in a range of about 15 microns to about 50 microns.

3. A kit as recited in claim 1, the polishing abrasive having a grit size in a range of about 70 microns to about 200 microns and the lusterizing abrasive having a grit size in a range of about 20 microns to about 45 microns.

4. A kit as recited in claim 1, the polishing abrasive having a grit size in a range of about 75 microns to about 150 microns and the lusterizing abrasive having a grit size in a range of about 25 microns to about 40 microns.

5. A kit as recited in claim 1, the polishing abrasive comprising agglomerates that, when exposed to oxygen and mechanical pressure during polishing, break down into smaller particles having a grit size in a range of about 10 microns to about 50 microns, the lusterizing abrasive comprising agglomerates that, when exposed to oxygen and mechanical pressure during lusterizing, break down into smaller particles having a grit size in a range of about 1 micron to about 20 microns.

6. A kit as recited in claim 1, the polishing abrasive comprising agglomerates that, when exposed to oxygen and mechanical pressure during polishing, break down into smaller particles having a grit size in a range of about 15 microns to about 45 microns, the lusterizing abrasive comprising agglomerates that, when exposed to oxygen and mechanical pressure during lusterizing, break down into smaller particles having a grit size in a range of about 2 microns to about 15 microns.

7. A kit as recited in claim 1, the polishing abrasive comprising agglomerates that, when exposed to oxygen and mechanical pressure during polishing, break down into smaller particles having a grit size in a range of about 20 microns to about 40 microns, the lusterizing abrasive comprising agglomerates that, when exposed to oxygen and mechanical pressure during lusterizing, break down into smaller particles having a grit size in a range of about 2.5 micron to about 10 microns.

8. A kit as recited in claim 1, further comprising at least one buffing pad or buffing cloth for applying the polishing and/or lusterizing compositions to a plastic surface, wherein the at least one buffing pad or buffing cloth is impregnated with glass fibers in order to enhance polishing efficacy of the polishing composition and/or lusterizing efficacy of the lusterizing composition.

9. A kit as recited in claim 1, wherein the UV protective composition comprises a UV protective material, a polymerizable material, and at least one solvent that causes the UV protective coating to anneal into a plastic surface when the UV protective composition is buffed onto the plastic surface.

10. A kit as recited in claim 9, the polymerizable material comprising an acrylic-urethane dispersion that polymerizes after application and forms a hard protective coating on the plastic surface.

11. A method for restoring optical clarity and light transmission properties to a plastic surface damaged by scratching and/or UV-induced oxidation, comprising:
polishing a plastic surface with a polishing composition applied to the plastic surface using at least one buffing pad or buffing cloth, wherein the polishing composition includes a polishing abrasive having a grit size in the range of about 50 microns to about 400 microns;
lusterizing the plastic surface with a lusterizing composition applied to the plastic surface using at least one buffing pad or buffing cloth, wherein the lusterizing composition includes a lusterizing abrasive having a grit size in the range of about 10 microns to about 60 microns; and
applying an ultraviolet protective coating to the plastic surface following polishing and lusterizing of the plastic surface, wherein the ultraviolet protective coating comprises at least one solvent that causes the UV protective coating to anneal to the plastic surface, at least one UV protective material to protect the plastic surface from UV-induced damage, and at least one polymerizable material that polymerizes after application and forms a hard protective coating on the plastic surface.

12. A method as recited in claim 11, wherein the buffing pad or buffing cloth is impregnated with glass fibers to enhance polishing and lusterizing.

13. A method as recited in claim 11, wherein the plastic surface comprises an automotive plastic light cover, a plastic sunglass lens, or a plastic corrective eyeglass lens

14. A kit for restoring optical clarity and light transmission properties to a plastic surface damaged by scratching and/or UV-induced oxidation, comprising:
at least one abrasive composition comprised of abrasive particles dispersed within a liquid or gel carrier, the abrasive particles initially comprising agglomerates having an initial particle size when stored in a substantially oxygen free environment that, when exposed to oxygen and mechanical pressure during polishing, progressively break down into smaller particles having a final particle size that is substantially smaller than the initial particle size, wherein the initial and final particle sizes are selected in order for the polishing composition to readily remove scratches and oxidation from a plastic surface; and
at least one UV protective composition for applying a UV protective coating to a plastic surface treated using the polishing and lusterizing compositions.

15. A kit as recited in claim 14, wherein the agglomerates are formulated so as to break down into smaller particles having a final particle size that is less than about 75% of the initial particle size.

16. A kit as recited in claim 14, wherein the agglomerates are formulated so as to break down into smaller particles having a final particle size that is less than about 50% of the initial particle size.

17. A kit as recited in claim 14, wherein the agglomerates are formulated so as to break down into smaller particles having a final particle size that is less than about 33% of the initial particle size.

18. A kit as recited in claim 14, wherein the agglomerates are formulated so as to break down into smaller particles having a final particle size that is less than about 20% of the initial particle size.

19. A method for restoring optical clarity and light transmission properties to a plastic surface damaged by scratching and/or UV-induced oxidation, comprising:
abrading a plastic surface with at least one abrasive composition comprised of abrasive particles dispersed within a liquid or gel carrier to a plastic surface, the abrasive particles initially comprising agglomerates having an initial particle size when stored in a substantially oxygen free environment that, when exposed to oxygen and mechanical pressure during abrading, progressively break down into smaller particles having a final particle size that is substantially smaller than the initial particle size, wherein the initial and final particle sizes are selected in order for the polishing composition to readily remove scratches and oxidation from a plastic surface; and
Ad applying an UV protective composition to the abraded plastic surface in a manner so as to form a hard UV protective coating that is annealed to the plastic surface.

20. A method as recited in claim 19, wherein the plastic surface comprises an automotive plastic light cover, a plastic sunglass lens, or a plastic corrective eyeglass lens.
